(19) United States
(12) Patent Application Publication
(10) Pub. No.: US 2007/0000759 A1
(43) Pub. Date: Jan. 4, 2007

(54) Transport vehicle comprising a movable loading floor, such a loading floor and slats for such a loading floor

(76) Inventor: Petrus Arnoldus Franciscus Antonius Knapen, Deurne (NL)

Correspondence Address: OLSON & HIERL, LTD., 20 NORTH WACKER DRIVE, 36TH FLOOR, CHICAGO, IL, 60606, US

(21) Appl. No.: 11/387,274

(22) Filed: Mar. 23, 2006

(30) Foreign Application Priority Data
Sep. 23, 2003 (NL) 1024356
Sep. 22, 2004 (WO) PCT/NL04/00656

(51) Int. Cl. B60P 1/36

(52) U.S. Cl. 198/527; 414/514; 198/521

(57) ABSTRACT

The invention relates to a transport vehicle comprising a load compartment having a front side and a rear side and a loading floor for supporting the load. The loading floor comprises conveyor belt means (3) that are moveable in a direction of movement between said front side and said rear side, and a support for the conveyor belt means, which is provided with transverse slats. The transport vehicle further comprises first accumulation means (4) for accumulating the conveyor belt means (3) near the rear side of the loading floor and first driving means for driving said first accumulation means (4). Adjacent slats (10, 11) interlock for transmitting pulling forces that occur in the conveyor belt means (3) during movement thereof.

The present invention relates to a transport vehicle comprising a load compartment having a front side and a rear side and a loading floor for supporting the load, said loading floor comprising conveyor belt means that are movable in a direction of movement between said front side and said rear side, and a support for the conveyor belt means, which is provided with transverse slats, said transport vehicle comprising first accumulation means for accumulating the conveyor belt means near the rear side of the loading floor and first driving means for driving said first accumulation means. The invention further relates to a loading floor for use with such a transport vehicle, to a uniform slat and to a load-bearing slat and a connecting slat for use with such a loading floor.

Such a transport vehicle is known from British patent application GB 2,101,555 A, which discloses a trailer comprising a load-carrying floor with a driven conveyor belt consisting of rigid, flexibly interconnected transverse slats extending over the floor, said slats being connected to chains, cables or belts that transmit the driving forces for moving the floor from one end of the trailer to the other. A drawback of the conveyor belt that is known from GB 2 101 555 A is the fact that, besides the slats, additional means are required for transmitting the forces needed for moving the floor and for connecting the slats to the force transmission means. This leads to a complex construction, and thus to high assembly costs and an increased risk of malfunction. In addition, openings will probably form between adjacent slats, in particular if the floor is being rolled away round the rear side of the load compartment, as it were, as a result of which dirt may collect between the slats, thereby interfering with the accumulation and deaccumulation process. This renders the system of slats unsuitable in particular for transporting bulk goods, but also for transporting all other goods that may lose material or from which dirt may fall.

British patent application GB 417,246 furthermore discloses a movable floor for automatically loading and unloading motorised lorries. The movable floor consists of a series of cross elements arranged side by side, which are hinged together by means of straps extending about the hinge pin. The rigid elements can be pulled to the rear by a polygonal sided drum and be wound on said drum. A drawback of that arrangement is the fact that adjacent slats do not interlock, as a result of which additional parts in the form of straps and hinge pins are required. This makes the assembly process very labourintensive.

European patent application EP 0 173 936 A2 furthermore discloses a lorry comprising a loading surface which is conveyed in the manner of a conveyor belt. The conveyorlike floor comprises selfsupporting, light metal extruded sections, which are capable of supporting a load. The extruded sections are provided at their longitudinal sides with positively interlocking coupling elements. The frontmost and the rearmost slat are interconnected by pull means, which extend under the loading floor when the loading floor is positioned inside the load compartment. To unload the vehicle, a driving drum, which rotates in anticlockwise direction, is activated, with the sections being pulled first about a return pulley at the rear side of the vehicle and then under the loading floor to the front side of the vehicle. A drawback of this arrangement is the fact that the sections are not accumulated, and the endless belt that is therefore needed makes it necessary to use a complicated construction for supporting the floor on the chassis.

British patent GB 327,772 finally discloses a loading floor for lorries comprising an endless slatted floor, wherein the slats are mounted on chains carried round a frame by means of chain wheels on either side of the slats. In said invention, neither accumulation means nor interlocking slats are used. Accordingly, the device in question exhibits the drawbacks both of GB 417,246 and of EP 0 173 936 A2 and GB 2,101,555 A.

The object of the present invention is to provide a transport vehicle which, whether or not in preferred embodiments thereof, obviates the above drawbacks, or at least in part, and which comprises a slatted floor having a substantially continuous load-bearing surface, which can move into and out of the transport vehicle, without any additional force transmission means being required. This object is achieved with a transport vehicle according to the invention in that adjacent slats interlock for transmitting pulling forces that occur in the conveyor belt means during movement thereof. With such an arrangement it is not necessary to provide additional means for transmitting the pulling forces, because the slat construction performs this function. In the absence of said additional means for transmitting the forces, means for attaching the slats thereto are not required, either. Additional means may nevertheless be provided, of course, to provide additional support or to prevent the slats moving with respect to each other in a direction transversely to the conveyor belt means.

Preferably, adjacent slats interlock at least substantially along their entire length. As a result, the pulling forces that are transmitted in use are distributed over the entire length of the slats.

In a further embodiment of the invention, the slats comprise an upper surface suitable for supporting a load present on the conveyor belt means and a lower surface suitable for supporting the conveyor belt means on the support. Because uniform slats performing a load-bearing function as well as a supporting function are used, the number of mutually different parts remains within bounds, thus enabling easy assembly of the floor.

In another embodiment according to the invention, the slats comprise load-bearing slats for supporting the load on the conveyor belt means and connecting slats different from the load-bearing slats for interconnecting the load-bearing slats and supporting the conveyor belt means on the support. An advantage of the use of mutually different slats is that the load-bearing slats can be optimized for supporting a load in the transport vehicle, whilst the connecting slats can be optimized for interconnecting the load-bearing slats and supporting the conveyor belt means on the support. As a result, less stringent requirements need to be made of the individual slats, so that the individual slats can be produced at lower cost than the multifunctional slats that halve been described above.

Furthermore it is preferable for the load-bearing slats to be spaced from the support. Since the load-bearing slats no longer come into contact with the support, the connecting slats can be optimally designed for being supported on a supporting surface, in this case the support.

The connecting slats are preferably different from the load-bearing slats as regards their shape and/or orientation. This makes it possible to adapt the shape of the slats to the respective load-bearing, connecting and supporting requirements. In addition, the slats may be oriented in such a manner that the load-bearing surface of the load-bearing slats faces upwards, i.e. in the direction of the load to be supported, whilst the supporting surface of the connecting slats faces downwards, i.e. towards the floor on which they are supported. In this way a construction of mating slats is formed, with the individual slats being optimally adapted for their respective functions. Moreover, the width, but also the thickness of the load-bearing slats in particular can be geared to the load (to be expected). This provides a saving in materials and thus in costs and weight.

In a preferred embodiment, the individual slats are symmetrically shaped in relation to a surface that is oriented perpendicularly to the direction of movement. As a result, the forces being transmitted upon movement of the conveyor belt means via the slats are evenly distributed over the two sides of the slats.

Preferably, adjacent slats comprise interlocking curved parts. In this way a simple mutual engagement of slats and an adequate transmission of the forces can be provided, Furthermore preferably, two interlocking curved parts have radii of curvature that are at least substantially the same. This has an advantageous effect on the symmetry of the forces that occur within a slat upon transmission of said forces during movement of the conveyor belt means.

Preferably, a sealing element is provided between two adjacent slats. The sealing element provides an adequate seal between adjacent slats and thus a substantially continuous load-bearing surface at the transition between two adjacent slats, since it bridges a space that may be present between two adjacent slats at the upper side thereof. In this way material is prevented from finding its way into the space between two adjacent slats, which might interfere with or even block the pivoting movement of the slats relative to each other. The sealing element may furthermore provide a good mutual guidance between two adjacent slats upon pivoting of the slats relative to each other during accumulation or de-accumulation. The mutual guidance of slats can be improved even further by providing a lubricant such as molybdenum disulphide between adjacent slats.

In another preferred embodiment according to the invention, the slats extend over substantially the entire width of the load compartment. As a result, an uninterrupted surface is obtained at least in the transverse direction of the conveyor belt means, so that no disturbances can occur between adjacent slats or in the driving mechanisms of two different parts of the conveyor belt means during the movement of the conveyor belt means.

The first accumulation means preferably comprise a first winding element. This makes it possible to wind the conveyor belt means on the first winding element, as a result of which the conveyor belt means will take up relatively little space in accumulated, i.e. wound condition. Another advantage of using a winding element as the accumulating element is that a winding movement is easy to drive and that malfunctions do not easily occur in the case of a winding movement. In addition, sufficient space for winding the conveyor belt means on the first winding element is as a rule present between the rearmost wheels and the rear end of the load compartment of a transport vehicle.

Preferably, an indentation having a depth equal to the height of the conveyor belt is present in the circumferential surface of the winding element at the location where the conveyor belt means is attached to the winding element. When the winding element has completed its first revolution, a gradual transition from the circumference of the winding element to the beginning of the conveyor belt means is provided. If such an indentation would not be provided, an unevenness would show up during winding.

In a preferred embodiment of the invention, the first driving means drive the winding element at a uniform speed. The diameter of the winding element with the (part of the) conveyor belt means that is wound thereon increases as the conveyor belt means is being wound on the winding element. In the case of a uniform rotational speed of the winding element, this will cause the speed at which the conveyor belt means is being moved out of the load compartment to become higher and higher.

In another preferred embodiment of the invention, said driving means drive the winding element with a retarded motion. This achieves that the speed at which the conveyor belt means moves out of the load compartment is maintained at a substantially uniform level. An advantage in this connection is that the torque being exerted on the winding element and the conveyor belt means is to a certain extent maintained at a constant level, at least that the peak value thereof is kept within bounds, while the conveyor belt means is being wound on the winding element.

The load-bearing slats preferably have a uniform width. In this way the number of different parts needed for assembling the conveyor belt means is minimised, and there is no need to make a selection from a collection of load-bearing slats having different widths all the time when assembling the conveyor belt means. This has a cost saving effect.

In another preferred embodiment, load-bearing slats that are positioned near the winding element are smaller in width than load-bearing slats that are further removed from the winding element. The narrow load-bearing slats make it possible to use a winding element having a relatively small outside diameter, because the first part of the conveyor belt means to be wound will assume a shape comprising a relatively large number of angles on account of the small width of the load-bearing slats, as a result of which the outer circumference of the winding element with the narrow slats present thereon is almost circular in shape. This enables an even winding of the conveyor belt means, also when a small diameter is used. As the winding of the conveyor belt means progresses, the circumferential dimension of the winding surface increases because more and more layers of conveyor belt means are wound on the winding element. As a result, the flexibility requirements made of the conveyor belt means can be less stringent and it is possible to use wider load-bearing slats, making it possible to minimize the number of load-bearing slats. This reduces the number of mounting operations to be carried out upon assembly of the conveyor belt means, as a result of which the production costs can be minimised.

The conveyor belt means preferably comprises an arched upper surface. This is advantageous in particular when unloading bulk goods. The arched profile is to provide a greater friction between the conveyor belt means and the load during movement of the conveyor belt means to the rear, so that the difference between the rate of movement of the load and the rate of movement of the conveyor belt means during unloading will remain as small as possible.

The slats that rest on the support in the unwound condition preferably have a concave bottom side, seen in cross-sectional view. Such a shape provides improved guiding characteristics of the conveyor belt means on the support. Furthermore, the concavity may substantially correspond to the convexity of the winding element and a return pulley over which the conveyor belt means is passed at the end of the loading floor upon being wound on and unwound from the winding element.

In a preferred embodiment, guide means are provided for guiding the slats from the point where they leave the load compartment until the point where they reach the winding element. The guide means ensure that the slats cannot move in transverse direction relative to each other when they are no longer confined as in the load compartment.

Preferably, the transport vehicle furthermore comprises at least one pulling element at the front side and second accumulation means for accumulating said at least one pulling element. A belt exhibiting sufficient tensile strength, for example a belt made of a synthetic material, suffices for unwinding the conveyor belt means from the winding element into the transport vehicle. Another advantage is the fact that such a belt takes up only little space in accumulated condition. When the second accumulation means with the belt accumulated thereon are present in the load compartment of the transport vehicle, the second accumulation means and the thin belt will take up relatively little costly storage space in comparison with a situation in which floor slats or chains functioning as pulling means would be accumulated at the front of the load compartment instead of the belt. A small volume of the whole is advantageous also in the situation in which the second accumulation means and the accumulated belt are present outside the load compartment.

The second accumulation means preferably comprise a winding element. Winding is a technically simple accumulation method and consequently it is advantageous to use this technique for the second accumulation means as well.

Preferably, second driving means are provided for driving the second accumulation means. This makes it easy to pull the conveyor belt means from the winding element into the transport vehicle. Since the thickness of the belt is minimal in relation to the diameter of the winding element, the working radius of the belt hardly increases, as a result of which the speed of the conveyor belt means does not increase appreciably during accumulation when a uniform angular velocity is used.

In a preferred embodiment of the invention, the transport vehicle comprises a movable partition that can move along with the conveyor belt means between the front side and the rear side of the load compartment. A movable partition has the advantage that no part of the load can fall between the movable partition and the front part of the conveyor belt means that moves towards the rear during movement of the conveyor belt means with the load present thereon to the rear side of the load compartment, i.e. during unloading. This might interfere with the operation of the driving means and, in addition, such part of the load remaining behind would have to be removed from the transport vehicle yet either by hand or by another, separate operation.

Preferably, the movable partition can move along with the conveyor belt means to the rear side of the load compartment in a retarded motion. Said retardation may be realised by starting the movement of the partition later than that of the conveyor belt means and also by moving the movable partition at a speed lower than that of the conveyor belt means. In either case some of the slats will extend beyond the conveyor belt means in the situation in which the conveyor belt means is fully unwound from the winding element, extending from the loading floor to the roof of the load compartment, for example, in which case the pulling element can be accumulated above or below, inside or outside the load compartment, in such a manner that the front end of the conveyor belt means, upon being moved in the load compartment towards the rear side thereof, will reach the rear end of the load compartment of the transport vehicle at the same time as the movable partition. This retardation makes it possible to reduce the resistance of the load while the conveyor belt means is moving towards the outside. The movement of the movable partition towards the front side of the load compartment may also take place in a retarded manner, although this is not necessary.

The conveyor belt means is preferably liquidtight. The transport vehicle may furthermore be provided with gutters that are oriented perpendicularly relative to the slats for the purpose of collecting any liquid that may be present on the sides of the conveyor belt means. A liquidtight conveyor belt means has the advantage that liquid present on the conveyor belt means cannot get under the conveyor belt means, where said liquid might have a destructive effect. Since measures are taken to collect liquid in gutters on the sides of the conveyor belt means, there is no risk of any polluting liquids landing from the transport vehicle on the public road via the conveyor belt means or finding their way into the environment in any other way.

According to another aspect, the invention relates to a conveyor comprising a conveyor belt means, characterized in that the conveyor belt means comprises transverse slats, wherein adjacent slats interlock for transmitting pulling forces that occur in the conveyor belt means during movement thereof. The advantages of such a conveyor are similar to the advantages that have been discussed in the foregoing in the discussion of the preferred embodiments of the transport vehicle according to the invention.

According to yet other aspects, the present invention relates to a slat for use in a transport vehicle or in conveyor belt means as discussed in the foregoing. The advantages of uniform slats and of load-bearing slats and connecting slats have likewise been discussed in the foregoing in the discussion of preferred embodiments of the transport vehicle according to the invention.

### DESCRIPTION OF THE FIGURES

Of the invention will now be explained in more detail by means of a description of an embodiments of the invention. Said embodiments are inter alia illustrated in the following schematic figures, in which like parts are provided with the same numerals and in which:

FIG. 1 is a perspective side elevation of an embodiment of a transport vehicle according to the present invention, which comprises a movable slatted floor, which extends over the entire load compartment;

FIG. 2 is a perspective side elevation of the transport vehicle of FIG. 1, in which the movable slatted floor is partially wound on the winding element;

FIG. 3 is a perspective front view of the transport vehicle of FIG. 2;

FIG. 4 is a side elevation of a movable slatted floor and a winding element comprising load-bearing slats and connecting slats;

FIG. 5a is a larger scale view of a detail of FIG. 4;

FIG. 5b is a view similar to FIG. 5a, in this case showing a loading floor comprising load-bearing slats that vary in length;

FIG. 6 is a side elevation of a return pulley and a conveyor belt means consisting of uniform slats;

FIG. 7a is a side elevation of a number of interconnected, uniform slats;

FIG. 7h is a side elevation of a connecting slat and two load-bearing slats, with two sealing strips present there between;

FIG. 8a is a top plan view of a part of a slatted floor and guides inside and outside the load compartment; and

FIG. 8b is a side elevation of slats and guides of figure 8a.

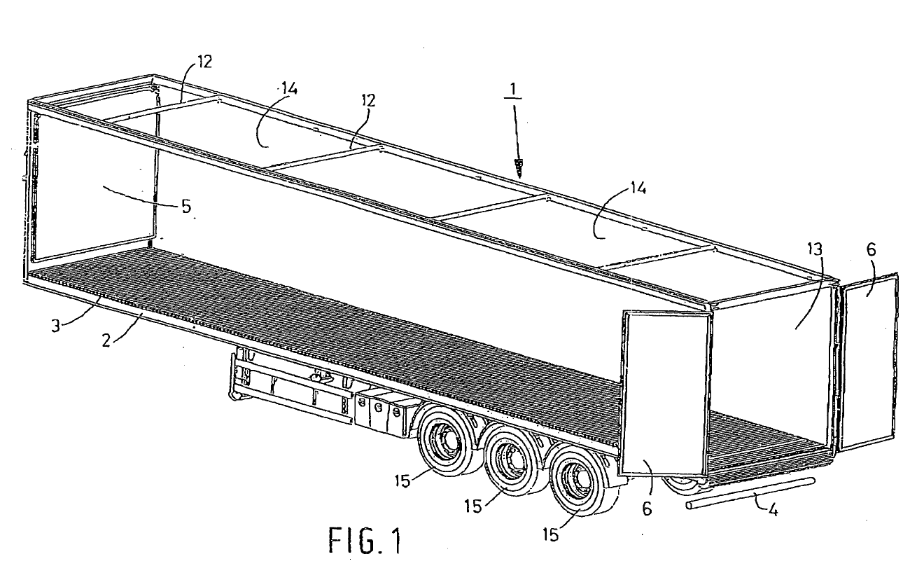

Referring to FIG. 1, a trailer 1 comprising a support 2 is shown, on the bottom of which a movable slatted floor 3 extends along the entire length of the support 2. The support 2 is bounded by side walls 14 (one of which has been left out for the sake of clarity), a loading opening 13 with doors 6 at the rear side and a movable partition 5 at the front side, and with cross members 12 present at the upper side for providing strength and supporting a roof covering, if present. The load compartment that is formed by said parts is supported on a traditional frame. The trailer 1 can be moved via wheels 15. Present at the rear side of the trailer 1 is a winding element 4 forming part of the first accumulation means, whose suspension and guides have been left out for the sake of clarity.

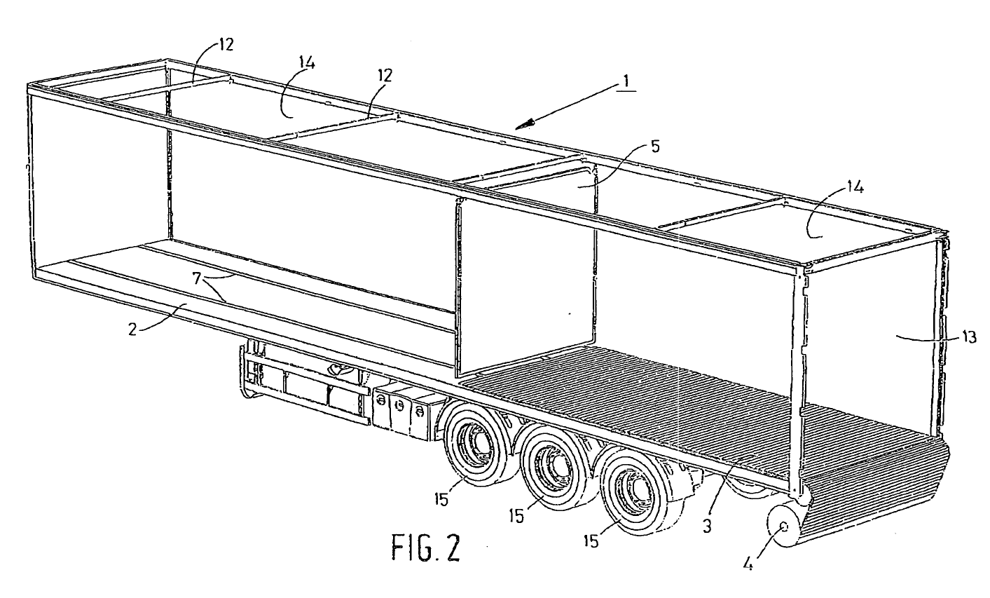

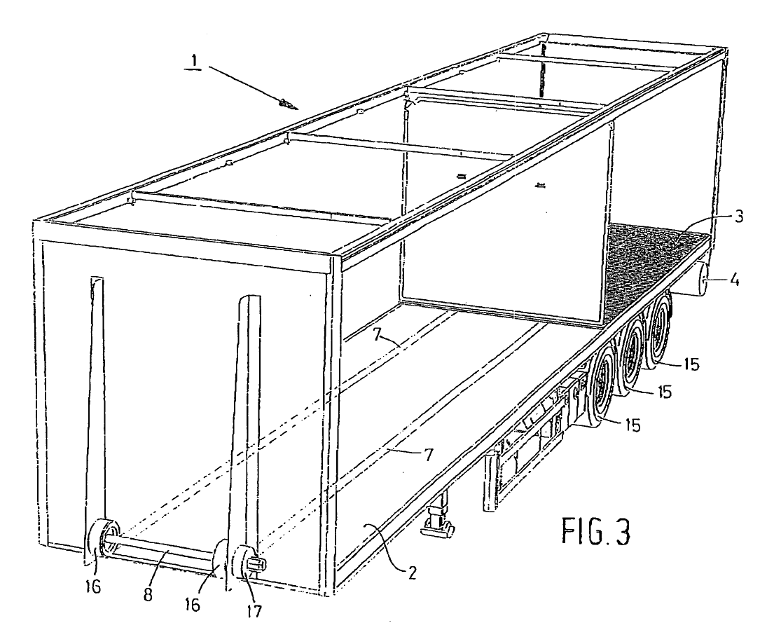

In FIGS. 2 and 3, the movable slatted floor 3 is partially wound on the winding element 4, and the movable partition 5 has moved towards the rear along with the front end of the movable slatted floor 3. As a result of that, two belts 7 of a synthetic material, Dyneema in this example, can be distinguished, which belts connect the movable slatted floor 3 with a shaft 8 that interconnects two winding elements 16 on which the Dyneema belts 7 can be wound. The shaft 8 is driven by a motor 17. Separate accumulation means may be provided for each pulling belt, each fitted with its own motor, for example a hydraulic motor.

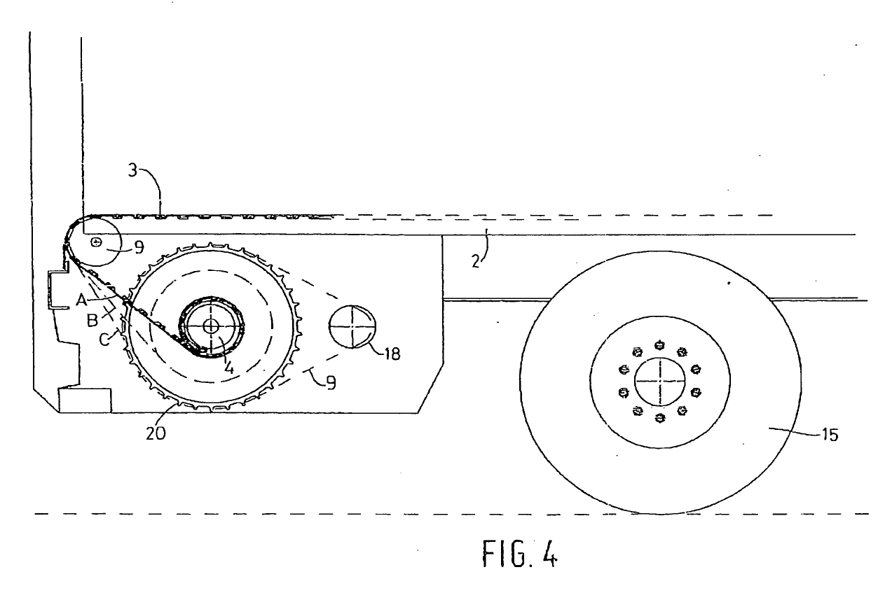

FIG. 4 shows in more detail the winding element 4 that is present near the rear side of the trailer 1, under the support 2, in which the letters A, B and C indicate 3 positions of a movable slatted floor 3, which is only partially wound on the winding element 4. The winding element 4 is driven by means of a drive shaft 18 that is driven by a motor (not shown), over which an endless drive chain 19 is passed, which chain is also passed over a chain wheel 20 of the winding element 4. A rotatably journalled return pulley 9 is provided at the rear side of the support 2 of the trailer 1 for guiding the movable slatted floor 3 while it is being wound on or unwound from the winding element 4. The return pulley 9 may be in one piece or be built up of several parts.

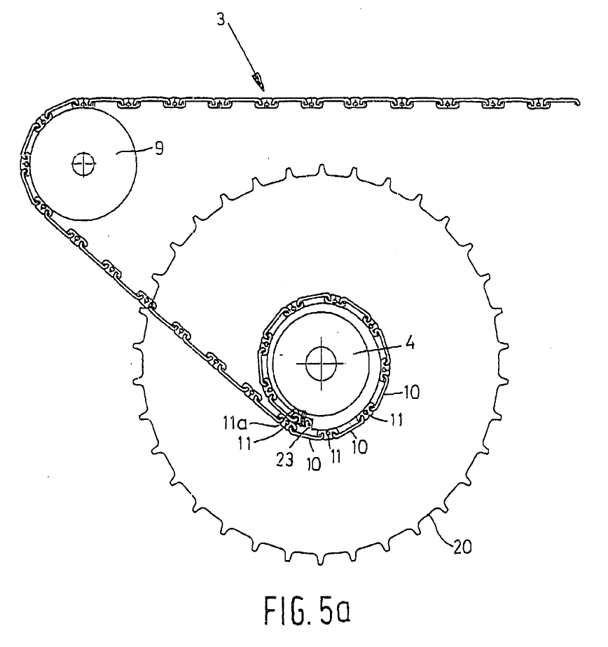

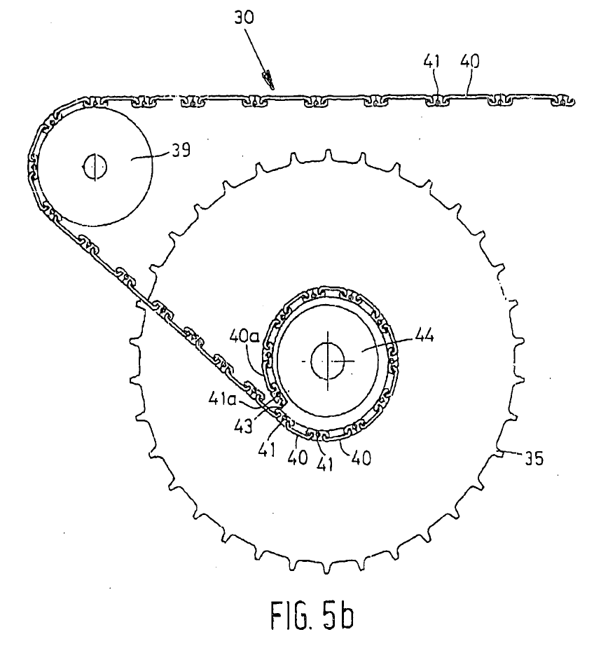

In FIG. 5a the return pulley 9, the winding element 4 and the movable slatted floor 3 are shown, whilst furthermore the orientation of the connecting slats 11 relative to the load-bearing slats 10 is shown. Furthermore, the figure clearly shows that the circumference of the winding element 4 exhibits an indentation 23, so that a smooth winding surface is provided during the winding movement also after the winding element 4 has completed one revolution. Because of the concave shape of the bottom side of the connecting slats 11 an adequate abutment between said connecting slats 11 and the surface of the return pulley 9 and the winding element 4 is obtained.

In FIG. 5b, a return pulley 39, a winding element 44 and a movable slatted floor 30 similar to those shown in FIG. 5a are shown, the difference being that the width of the load-bearing slats 40 increases as the distance from the winding element 44 increases. The first load-bearing slat 40a beside the connecting slat 41a that is fixed to the winding element 44 beside the indentation 43 exhibits the smallest width. The width increases in the direction of the return pulley 39 and further to the front in the load compartment. The connecting slats 41 all have substantially the same dimensions. When the winding element 44 is driven via the chain wheel 35, the working radius of the winding element 44 increases, so that also the distance spanned by a load-bearing slat at the outer circumference of the winding element 44 with a (partially) wound conveyor belt means 30 present thereon may increase.

FIG. 6 shows a detail view of the return pulley 9, over which a movable slatted floor 3 consisting of uniform slats 21 is passed.

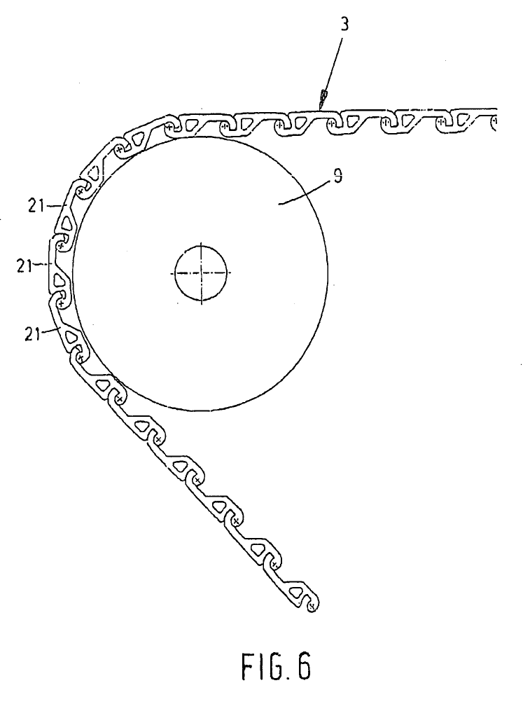

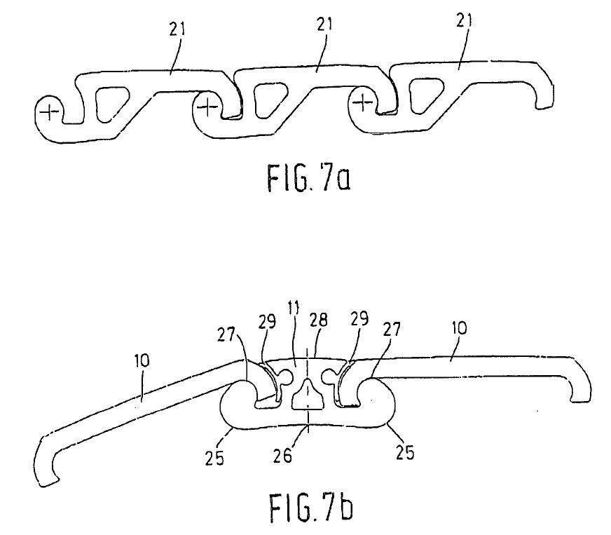

FIGS. 7a and 7b show a number of uniform slats 21 (FIG. 7a) and load-bearing slats 10 and connecting slats 11 (FIG. 7b) positioned adjacently to each other of a movable slatted floor 3, with sealing strips 29 present between the load-bearing slats 10 and the connecting slats 11 in FIG. 7b for guiding the load-bearing slats 10 during their pivoting movement within the connecting slats 11,

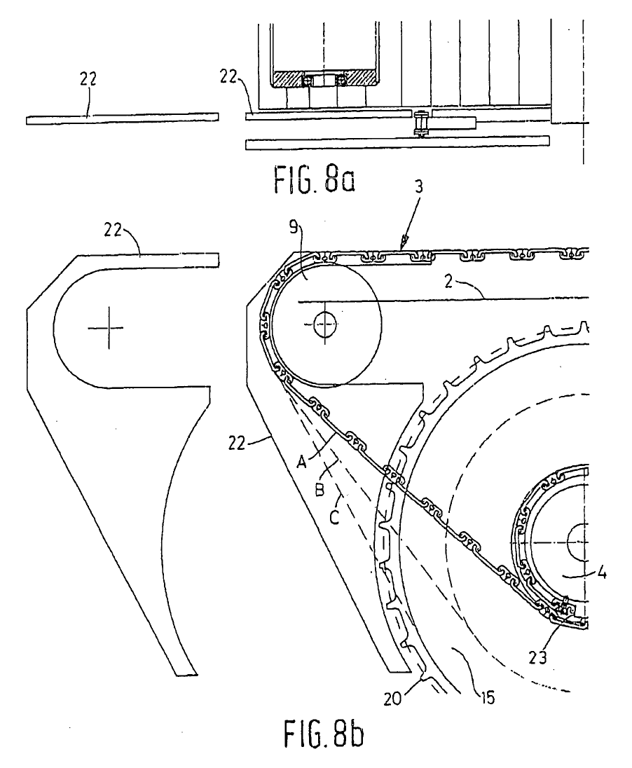

FIGS. 8a and 8b are a top plan view and a side view, respectively, of a guide plate 22 for guiding a movable slatted floor 3 from the point where said movable slatted floor 3 leaves the load compartment until the point where the movable slatted floor 3 moves onto the chain wheels 20, which also function as guides for a movable slatted floor 3 that is wound on or unwound from the winding element 4.

FIGS. 1, 2 and 3 show a trailer 1 which is used for the transportation of bulk goods. For the sake of clarity, the nearest side wall has been left out, providing a good view of the way in which the movable slatted floor 3 and the movable partition 5 cooperate with the support 2, the winding element 4, the Dyneema belt 7 and the winding elements 16 on the shaft 8. As a mater of fact, a movable slatted floor 3 according to the invention may just as well be used in a trailer for the transportation of pallets or other parcel goods. The kind of goods being transported with such a trailer 1 is not relevant for the operation of the movable slatted floor 3.

The trailer 1 can be loaded by placing goods (not shown) on the movable slatted floor 3 through the loading and unloading opening 13 at the rear side, with the doors 6 in the open position. Said loading may also take place from the upper side for that matter, through the spaces between the cross members 12 of the roof, in which case the movable slatted floor 3 will extend over the entire support 2 during loading.

When the trailer 1 is loaded through the opening at the rear side, with the doors 6 in the open position, the movable slatted floor 3 is preferably wound on the winding element 4 to substantially the rearmost position at the start of the loading process. The movable partition 5 may likewise be positioned near the loading and unloading opening 13 of the trailer 1. The front part of the movable slatted floor 3, which is wound on the winding element 4 to substantially the rearmost position, is loaded through the loading and unloading opening 13. During loading, the movable slatted floor 3 is pulled to the front via the Dyneema belts 7 by the driving motor 17 for the winding element 16, and that at a speed such that the movable slatted floor 3 is on the one hand maximally loaded, whilst on the other hand the loading process can take place entirely at the rear side of the trailer 1. The movable slatted floor 3 is gradually pulled further and further into the load compartment until the movable slatted floor 3 extends over the entire support 2. Following that, the doors 6 are closed and the trailer 1 is ready for transport.

When a movable slatted floor is used, it is possible to position the load as desired when the load compartment is partially loaded, this in contrast to the situation in which an immovable loading floor is used, in which case the load is as a rule positioned as far to the front in the load compartment as possible. Positioning the load further towards the rear, in this case, makes it possible to move the centre of gravity, so that the driving characteristics of a transport vehicle can be positively influenced and situations can be prevented in which one of the axles of the transport vehicle is loaded more heavily than is legally permitted as a result of the uneven distribution of the load over the load compartment.

The movable slatted floor 3 operates in the reverse order when the trailer 1 is being unloaded. The trailer 1 is positioned at the correct place and the doors 6 are opened. Then the driving motor (not shown) for the winding element 4 is activated, causing the movable slatted floor 3 to be wound on the winding element 4, as a result of which the movable slatted floor will move towards the rear. The load (not shown) can be removed from the movable slatted floor, using unloading means, or be deposited on the ground, a conveyor belt or other supporting surface behind the trailer 1. When the load is deposited on the ground, the trailer 1 may be moved forward while it is being unloaded so as to prevent the load from accumulating to the extent that it interferes with the unloading process. This continues until the movable slatted floor 3 has been wound completely, i.e. until the front part of the movable slatted floor 3 is present at the rear end of the load compartment. Depending on the embodiment that is used, the movable partition 5 either takes up a fixed position at the front side of the trailer 1, or the movable partition 5 has moved along with the movable slatted floor 3 to a position at the rear of the trailer 1. In the latter case, the trailer 1 is completely empty when the movable slatted floor 3 and the movable partition 5 are present at the end of the trailer 1. When the movable partition 5 has not moved along with the movable slatted floor 3, part of the load which has fallen on the support 2 during the unloading process of the movable slatted floor 3 may still be present in front of the movable slatted floor.

As FIG. 4 and FIG. 3 show, the winding diameter is relatively small (A) at the beginning of the winding movement of the movable slatted floor 3 on the winding element 4. The winding diameter gradually increases (B, C) as the winding process proceeds. The reason for this is that the winding diameter increases by at least twice the thickness of the movable slatted floor 3 with every rotation of the winding element 4. In the case of a steady rotary motion of the winding element 4, this means that the velocity of movement of the movable slatted floor 3 relative to the support 2 increases further and further, because a greater length of the movable slatted floor 3 is wound on the winding element 4 with every rotation of the winding element 4, and the front part of the movable slatted floor 3 will move towards the rear part of the load compartment over a distance that corresponds to one winding. To that end, the rotary motion of the winding element 4 can be retarded by the driving motor (not shown) as the winding diameter increases, i.e. from situation A, via situation B, to situation C. Such a provision is less necessary at the shaft 8 for the Dyneema belt 7, because of the relatively small thickness of the Dyneema belt 7 in comparison with the diameter of the winding element 16, as a result of which the increase of the winding diameter of the winding element 16 plus the Dyneema belt 7 during the winding process is relatively small. As a result, the working radius of the winding element and the speed of the movable slatted floor 3 remains substantially equal when the movable slatted floor 3 is unwound at a uniform rotational speed by means of the shaft 8 and the winding element 16, this in contrast to the situation with the winding element 4. It is possible to use a relatively small width for the load-bearing slats 10 or the uniform slats 21 that are present near the winding element 4 in the wound-up condition of the movable slatted floor 3, so that the movable slatted floor 3 can wind itself on a winding element 4 having a relatively small diameter. As a result, the diameter of the winding element 4 with the movable slatted floor 3 wound thereon will remain within bounds.

In FIG. 5 the winding element 4 and the return pulley 9 are shown in more detail, with the figure showing the manner in which the connecting slats 11 are supported on the winding element 4 and the return pulley 9. The figure furthermore shows that the presence of the indentation 23 near the place of attachment of the first slat 11a ensures that a smooth winding surface is obtained after the winding element 4 has completed one revolution. FIG. 6 furthermore shows the manner in which the return pulley 9 mates with uniform slats 21.

The shape of the uniform slats 21 or of the connecting slats 11 and the load-bearing slats 10 to a large extent determines the operation of a roll-up slatted floor 3. Preferably, all the slats 10, 11, 21 extend over the entire width of the support (which is not shown in FIGS. 7a and 7b). FIGS. 7a and 7b show the cooperation between adjacent uniform slats (FIG. 7a) and between the connecting slats 11 on the one hand and the load-bearing slats 10 on the other hand (FIG. 7b). A connecting slat 11 has a slightly concave bottom side, so that it is only supported on a support (not shown in FIG. 6) near the front side and the rear side as indicated at 25. As a result, the friction that the movable slatted floor 3 encounters during its movement into and out of the trailer 1 is minimised. As a result, the bottom side of a connecting slatted 11 is concave in shape, and the central portion 26 of a connecting slat 11 does not come into contact with a support 2 on which the connecting slats 11 is supported. A connecting slat 11 is provided with contact surfaces 27 for load-bearing slats at a position above the supporting surfaces 25. Said contact surfaces 27 are arcuate in shape, so that an adequate support for the load-bearing slats 10 is provided in the situation in which a load is present thereon, whilst on the other hand a good contact surface 27 for the load-bearing slats is provided in the situation in which the movable slatted floor 3 is being moved into or out of the load compartment. The upper surface 28 of a connecting slat 11 is convex in shape, as a result of which a movable slatted floor 3 extending over the support 2 of the trailer 1 exhibits an arched profile, seen in the longitudinal direction. The load-bearing slats 10 exhibit the profile of an inverted U having a flat upper side. The distance which the flat upper side bridges may vary. The load-bearing slats 10 make contact with the contact surface 21 of the connecting slats 11 on the inner side, whilst a sealing strip 29 is present between a connecting slat 11 and a load-bearing slats 10 on the other side. The sealing strip 29 sealingly bridges the space between & connecting slat 11 and a load-bearing slat 10, in such a manner that the movable slatted floor 3 is sealed liquid tight on the upper side, and in addition to that the sealing strip guides the movement of a load-bearing slat 10 that pivots with respect to a connecting slat 11.

FIGS. 8a and 8b are detail views of the manner in which the movable slatted floor 3 is guided upon being wound on or unwound from the winding drum 4. A guide plate 22 is provided, the shape of which guide plate and the attachment thereof to the rear part of the trailer 1 being such that the slats 10, 11, 21, which are guided by the side walls 14 of the trailer 1 when present inside the load compartment and by the chain wheels 20 beside the winding drums 4 when present on the winding drum 4, are also guided by guide plates 22 when present in the space between the side walls 14 and the chain wheels 20. In this way it is ensured that the slats 10, 11, 21 are laterally guided during their entire path of movement, as a result of which the risk of lateral displacement is excluded. The advantage of this is that the slats 10 and 11 or 21 can be moved into and out of engagement with each other during assembly or maintenance without any fastening means or fastening operations being required, with the possible exception of sealing strips 29, which are provided in the same manner. It will be understood that by obviating the use of further connecting means between adjacent slats (and connecting strips), a considerable gain in time can be realised upon assembly and disassembly of a movable slatted floor according to the invention.

To those skilled in the art, it will be apparent that many variants to the transport vehicle and the movable slatted floor and the slats as described above are possible. The above description and the figures merely show and describe preferred embodiments of the invention by way of example, the description of the figures is not intended to limit the scope of the invention.

1. A transport vehicle comprising a load compartment having a front side and a rear side and a loading floor for supporting a load, said loading floor comprising a conveyor belt that is movable in a direction of movement between said front side and said rear side, and a support for the conveyor belt, which is provided with transverse slats, said transport vehicle comprising a first accumulation member for accumulating the conveyor belt near the rear side of the loading floor and a first driving member for driving said first accumulation member, characterized in that adjacent slats interlock for transmitting pulling forces that occur in the conveyor belt during movement thereof.

2. A transport vehicle according to claim 1, characterized in that adjacent slats interlock at least substantially along their entire length.

3. A transport vehicle according to claim 1, characterized in that the slats comprise an upper surface suitable for supporting a load present on the conveyor belt and a lower surface suitable for supporting the conveyor belt on the support.

4. A transport vehicle according to claim 1, characterized in that the slats comprise load-bearing slats for supporting the load on the conveyor belt and connecting slats different from the load-bearing slats for interconnecting the load-bearing slats and supporting the conveyor belt on the support.

5. A transport vehicle according to claim 4, characterized in that said load-bearing slats are spaced from the support.

6. A transport vehicle according to claim 4, characterized in that said connecting slats are different from the load-bearing slats as regards at least one of their shape and their orientation.

7. A transport vehicle according to claim 1, characterized in that the individual slats are symmetrically shaped relative to a surface that is oriented perpendicularly to the direction of movement.

8. A transport vehicle according to claim 1, characterized in that adjacent slats comprise interlocking curved parts.

9. A transport vehicle according to claim 8, characterized in that two interlocking curved parts have radii of curvature that are at least substantially the same.

10. A transport vehicle according to claim 1, characterized in that a sealing element is provided between two adjacent slats.

11. A transport vehicle according to claim 1, characterized in that the slats extend over substantially the entire width of the load compartment.

12. A transport vehicle according to claim 1, characterized in that the first accumulation member comprises a first winding element.

13. A transport vehicle according to claim 12, characterized in that the winding element includes a surface defining an indentation having a depth equal to the height of the conveyor belt at a location where the conveyor belt is attached to the winding element.

14. A transport vehicle according to claim 12, characterized in that the first driving member drives the winding element at a uniform speed.

15. A transport vehicle according to claim 14, characterized in that the first driving member drives the winding element with a retarded motion.

16. A transport vehicle according to claim 4, characterized in that the load-bearing slats have a uniform width.

17. A transport vehicle according to claim 12, characterized in that load-bearing slats that are positioned near the winding element are smaller in width than load-bearing slats that are further removed from the winding element.

18. A transport vehicle according to claim 1, characterized in that the conveyor belt comprises an arched upper surface.

19. A transport vehicle according to claim 1, characterized in that the slats that rest on the support in the unwound condition have a concave bottom side, seen in cross-sectional view.

20. A transport vehicle according to claim 1, characterized in that a guide member is provided for guiding the slats from the point where they leave the load compartment until the point where they reach the winding element.

21. A transport vehicle according to claim 1, characterized in that the conveyor belt comprises at least one pulling element at the front side.

22. A transport vehicle according to claim 1, characterized in that the transport vehicle is provided with a second accumulation member for accumulating said at least one pulling element.

23. A transport vehicle according to claim 22, characterized in that the second accumulation member comprises a winding element.

24. A transport vehicle according to claim 22, characterized in that a second driving member is provided for driving the second accumulation member.

25. A transport vehicle according to claim 1, characterized in that the transport vehicle comprises a movable partition that can move along with the conveyor belt between the front side and the rear side of the load compartment.

26. A transport vehicle according to claim 25, characterized in that the movable partition can move along with the conveyor belt to the rear side of the load compartment in a retarded motion.

27. A transport vehicle according to claim 1, characterized in that the conveyor belt is liquidtight.

28. A conveyor comprising a conveyor belt, characterized in that the conveyor belt comprises transverse slats, wherein adjacent slats interlock for transmitting pulling forces that occur in the conveyor belt during movement thereof

29. A slat for use in a transport vehicle or a conveyor belt according to claim 1.
